(19) United States
(12) Patent Application Publication
(10) Pub. No.: US 2022/0349135 A1
(43) Pub. Date: Nov. 3, 2022

(54) PORTABLE KIOSK BASE

(71) Applicant: Miles Iventosch, Wilmington, NC (US)

(72) Inventor: Miles Iventosch, Wilmington, NC (US)

(21) Appl. No.: 17/306,379

(22) Filed: May 3, 2021

(51) Int. Cl. E01F 15/14; F16M 3/00; G06Q 20/18

(52) U.S. Cl. CPC E01F 15/14; F16M 3/00; G06Q 20/18

(57) ABSTRACT

The invention is generally directed to a portable kiosk base that can be used for a variety of purposes, such as (but not limited to) a parking kiosk base. The base comprises a support foundation and a series of protective bollards positioned on the top face of the foundation. The foundation provides a support for a corresponding kiosk, while the bollards prevent damage to the kiosk from cars, vandalism, and so forth. It should be appreciated that the base can support any of a wide variety of kiosks, such as ticketing kiosks for parking and the like.

### TECHNICAL FIELD

The presently disclosed subject matter is generally directed to a portable base for use with a kiosk or other large equipment.

### BACKGROUND

Millions of drivers park their vehicles daily in parking lots or in garage facilities. Conventional parking lot and garage systems include a plurality of parking spaces and a kiosk that accepts payment and produces tickets, allowing a user to access the parking spaces. Often, drivers will interact with the parking kiosk when they enter the parking lot or garage to receive an entry ticket. The driver will then insert the ticket into the kiosk when they leave the parking lot or garage, with payment for the length of the time spent parked in the facility. In other situations, drivers interact with the parking kiosk a single time to pre-pay for time to be spent in the parking facility. However, conventional kiosks are inconvenient in that they are permanently mounted at a desired location. When the kiosk is no longer used or needed, the base is destroyed, and a new base constructed for use at a later location. It would therefore be beneficial to provide a portable kiosk base that can be moved from a first location to a second location as desired by the user.

### SUMMARY

In some embodiments, the presently disclosed subject matter is directed to a kiosk base. The kiosk base comprises a foundation defined by a top face with an outer edge, an opposed bottom face, and a sidewall that extends between the top face and bottom face. The base further includes one or more bollards positioned on the top face of the foundation, at or adjacent to the outer edge. The sidewall includes one or more apertures that extend into an interior of the sidewall.

In some embodiments, the foundation top face further includes a recess.

In some embodiments, the kiosk base further incudes a kiosk positioned within the recess.

In some embodiments, the recess is positioned in an approximate center portion of the foundation top face.

In some embodiments, the apertures extend into the interior of the sidewall about 10-30 inches.

In some embodiments, a first aperture differs from a second aperture with regard to size, shape, or both.

In some embodiments, the kiosk base comprises two apertures.

In some embodiments, a first aperture is spaced 6-24 inches from a second aperture on the sidewall.

In some embodiments, the foundation sidewall is rotatable relative to the top face, bottom face, or both.

In some embodiments, the kiosk base comprises about 1-6 bollards.

In some embodiments, the bollards are releasably attached to the top face of the foundation.

In some embodiments, the kiosk base includes a distance between adjacent bollards of about 3-15 inches.

In some embodiments, the foundation, at least one bollard, or both further includes at least one light source.

In some embodiments, the presently disclosed subject matter is directed to a method of moving a kiosk base from a first location to a second location. Particularly, the method includes positioning the disclosed kiosk base at a first location. The method includes relocating the kiosk base to a second location by inserting an object into each aperture to lift the kiosk base and transport it to the second location. The method includes removing the objects from the apertures, whereby the kiosk base is moved from a first location to a second location.

In some embodiments, each object is a fork of a forklift.

In some embodiments, the bollards are removed prior to the relocating step.

In some embodiments, the method further includes releasably attaching a kiosk onto the top face of the kiosk base.

### BRIEF DESCRIPTION OF THE DRAWINGS

FIG. 1 is a perspective view of a portable kiosk base in accordance with some embodiments of the presently disclosed subject matter.

FIG. 2a is a perspective view of a foundation in accordance with some embodiments of the presently disclosed subject matter.

FIG. 2b is a top plan view of a foundation comprising a central recess in accordance with some embodiments of the presently disclosed subject matter.

FIGS. 2c and 2d are top plan views of foundations in accordance with some embodiments of the presently disclosed subject matter.

FIG. 2e is a fragmentary side plan view of a foundation in accordance with some embodiments of the presently disclosed subject matter.

FIG. 3a is a front plan view of a foundation comprising a pair of apertures in accordance with some embodiments of the presently disclosed subject matter.

FIG. 3b is a top plan view of a foundation illustrating apertures in accordance with some embodiments of the presently disclosed subject matter.

FIG. 3c is a fragmentary front plan view of a foundation comprising apertures in accordance with some embodiments of the presently disclosed subject matter.

FIG. 3d is a perspective view illustrating one embodiment of a foundation with a rotatable sidewall.

FIG. 4 is a perspective view with an optional holder in accordance with some embodiments of the presently disclosed subject matter.

FIG. 5a is a front plan view of a portable kiosk base in accordance with some embodiments of the presently disclosed subject matter.

FIG. 5b is a perspective view of a bollard in accordance with some embodiments of the presently disclosed subject matter.

FIG. 6a-6g are cross-sectional views of bollards in accordance with some embodiments of the presently disclosed subject matter.

FIG. 7 is a top plan view of a kiosk base in accordance with some embodiments of the presently disclosed subject matter.

FIG. 8 is a front plan view of a base comprising lighting in accordance with some embodiments of the presently disclosed subject matter.

FIG. 9 is a schematic illustrating one method of using the kiosk base in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

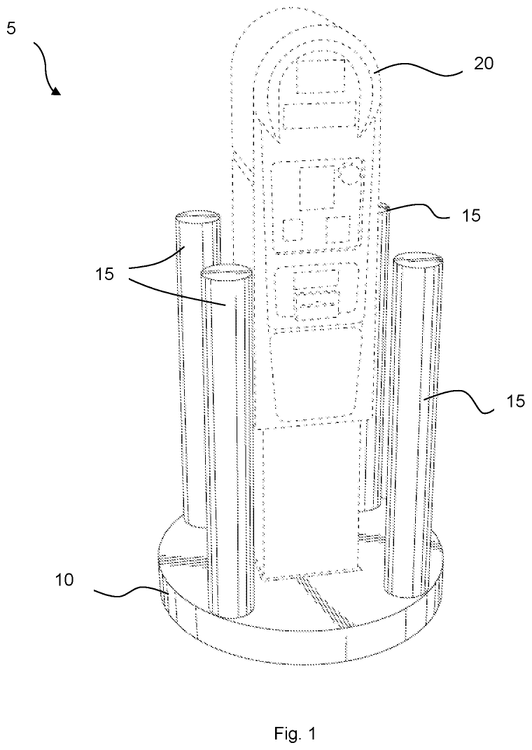

The presently disclosed subject matter is generally directed to a portable kiosk base that can be used for a variety of purposes, such as (but not limited to) a parking kiosk base. The term “portable” refers to a device that is capable of being transported or moved from a first location to a second location. The term “kiosk” refers to any standalone structure from which items can be vended. FIG. 1 illustrates one embodiment of base 5 comprising foundation 10 and a series of bollards 15 positioned on the top face of the foundation. The foundation provides a support for kiosk 20, while the bollards prevent damage to the kiosk from cars, vandalism, and so forth. It should be appreciated that the base can support any of a wide variety of kiosks 20, such as ticketing kiosks for parking and the like.

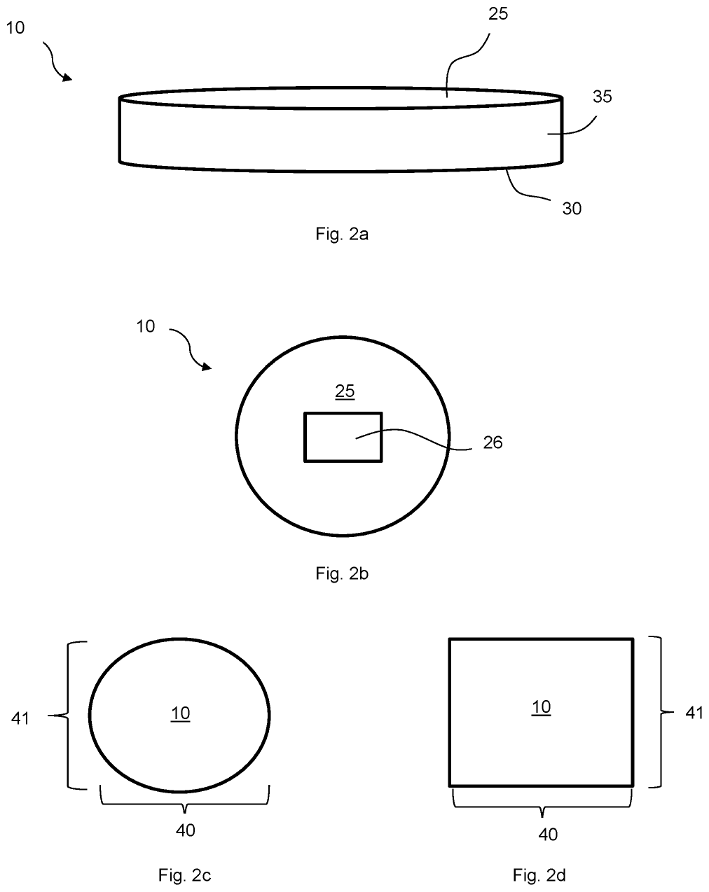

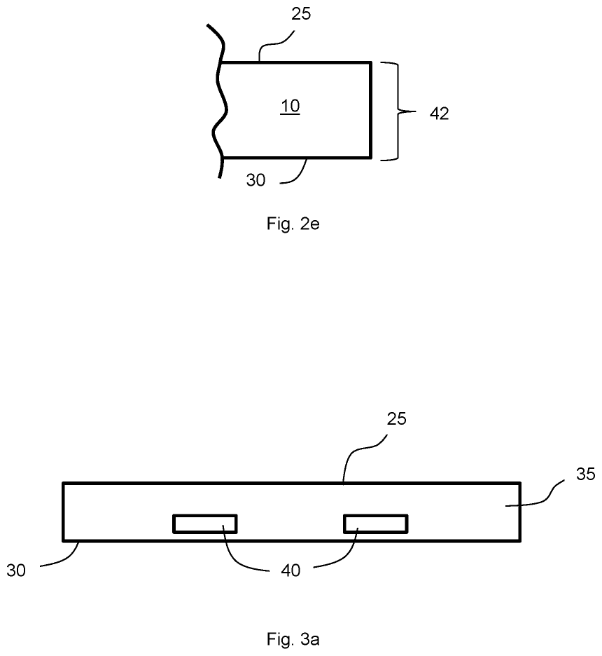

FIG. 2a illustrates one embodiment of foundation 10 that can be used with base 10. As shown, each foundation includes top face 25 and opposed bottom face 30. The top face of the foundation faces upwards, towards the kiosk. The bottom face rests on a support surface, such as the ground. One or more sidewall 35 extends about the perimeter of the foundation between the top and bottom faces. As shown in FIG. 2b, the top surface of foundation 10 can include recess 26 sized and shaped to cooperate with a corresponding kiosk. In this way, the kiosk is held within the foundation and is stabilized so that it does not tip over. Recess 26 can have any desired size to accommodate a corresponding kiosk. The depth of the recess can range from about 1-10 inches or more (e.g., at least/no more than about 1, 2, 3, 4, 5, 6, 7, 8, 9, or 10 inches).

Foundation 10 can have length 40 and/or width 41 of about 10-100 inches (e.g., at least/no more than about 10, 20, 30, 40, 50, 60, 70, 80, 90, or 100 inches), as illustrated in FIGS. 2c and 2d. The term “length” refers to the longest horizontal distance of the foundation. The term “width” refers to the longest distance perpendicular to the length. Foundation 10 further includes thickness 42 of about 3-20 inches (e.g., at least/no more than about 3, 4, 5, 6, 7, 8, 9, 10, 11, 12, 13, 14, 15, 16, 17, 18, 19, or 20 inches). The term “thickness” refers to the longest vertical distance between the top and bottom faces of the foundation, as shown in FIG. 2e.

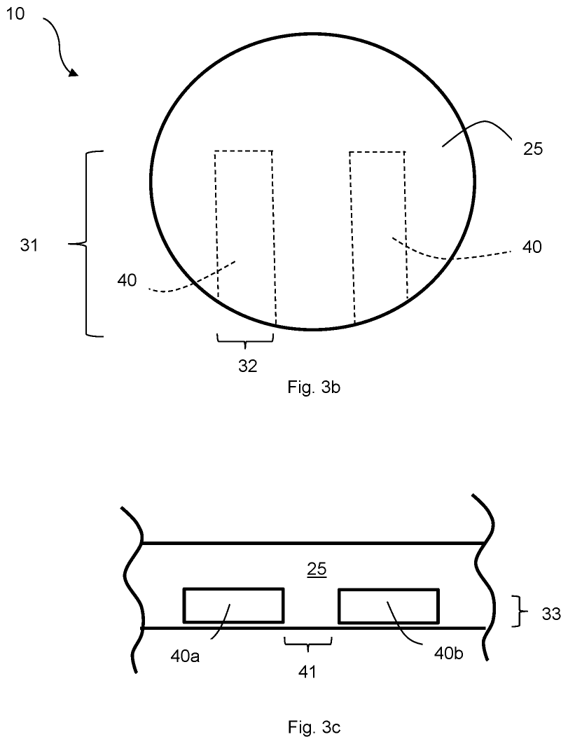

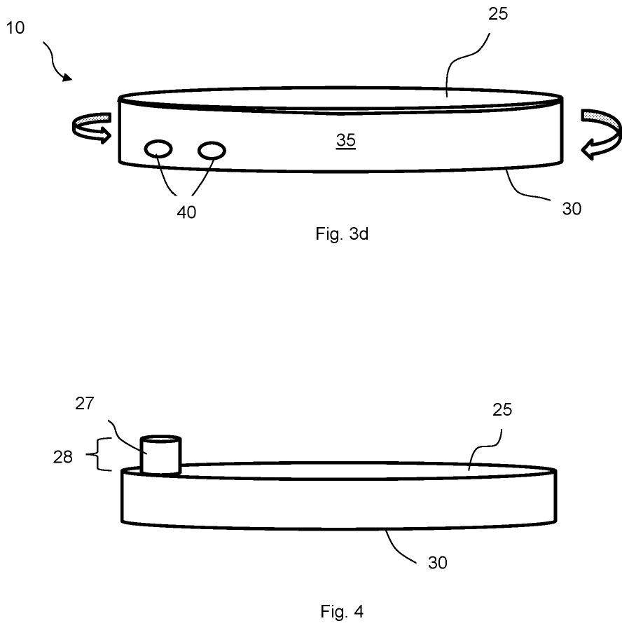

In some embodiments, sidewall 35 can include one or more apertures 40 that extend into the interior of the foundation, as shown in FIGS. 3a and 3b. The apertures can be used to transport the base from one location to another, such as through the use of a forklift or other piece of equipment. The apertures can be configured in any desired size and/or shape. For example, the apertures can have a round, oval, square, rectangular, triangular, or pentagonal shape. Further, the apertures can have length 31, width 32, and/or thickness 33 of about 3-30 inches (e.g., at least/no more than about 3, 5, 10, 15, 20, 25, or 30 inches). All apertures can have about the same size and/or shape. Alternatively, at least one aperture can differ from at least one other aperture with respect to shape and/or size.

Foundation can include any number of apertures 40, such as about 1-10 (e.g., 1, 2, 3, 4, 5, 6, 7, 8, 9, or 10). The apertures can be positioned about the circumference of the foundation sidewall. For example, the distance 41 between first and second apertures 40a, 40b can be about 6-24 inches apart, as shown in FIG. 3b. However, it should be appreciated that the presently disclosed subject matter is not limited and the distance between adjacent apertures can be greater or less than the range given herein.

Apertures 40 can be positioned at any location on sidewall 25. In some embodiments, the apertures can be positioned adjacent to bottom face 30 to prevent damage when moving the base from one location to another. Thus, the apertures can be positioned about 0.5-5 inches from bottom face 30. However, any configuration of apertures 40 can be used with the disclosed base.

In some embodiments, the sidewall can rotate relative to the top and/or bottom face of the foundation to allow the position of apertures 40 to be adjusted, such as for optimal access by a forklift or other machinery. Specifically, FIG. 3d illustrates one embodiment depicting sidewall 35 comprising apertures 40. The sidewall is configured to rotate relative to the top face of the foundation. Any conventional mechanism can be used to rotate the sidewall, such as (but not limited to) a central foundation axis that allows the sidewall to spin thereabout. Sidewall 35 can rotate in a clockwise direction, counterclockwise direction, or both.

In some embodiments, the foundation can optionally include holder 27 configured on top face 25, as shown in FIG. 4. Particularly, the holder can house a sign (e.g., instructional sign) that provides information for users on how to use the base and/or kiosk. Holder 27 can be constructed as a hollow cylindrical tubing, although any configuration can be included in the base. Holder can have height 28 of about 1-5 inches in some embodiments, although the height is not limited.

It should be appreciated that although foundation 10 is illustrated as circular in shape (e.g., top plan view), the foundation can have any desired shape, such as oval, square, rectangular, triangular, and the like.

Foundation 10 can be constructed from any desired material, such as (but not limited to) metal (e.g., steel), concrete, wood, plastic, or combinations thereof. For example, the foundation can be constructed from 0.5 inch steel flatbar and 40 inch flat steel circle, filled with 4000 psi high strength concrete. It should be appreciated that this is merely one example, and the foundation can be constructed from a wide variety of materials.

The foundation can have a weight substantial enough to prevent movement of the base without proper machinery (e.g., a forklift). For example, the foundation (and/or base) should have a weight such that it cannot be knocked over by a person or vehicle. Thus, the weight of the foundation can be greater than about 300 pounds (e.g., between about 300-2000 pounds). However, the weight of the foundation is not limited and can be less than or greater than the range set forth herein.

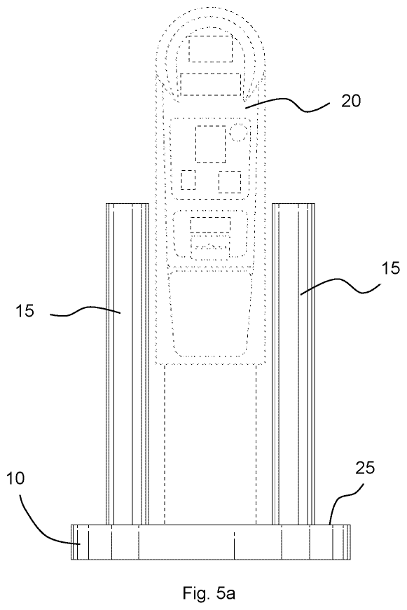

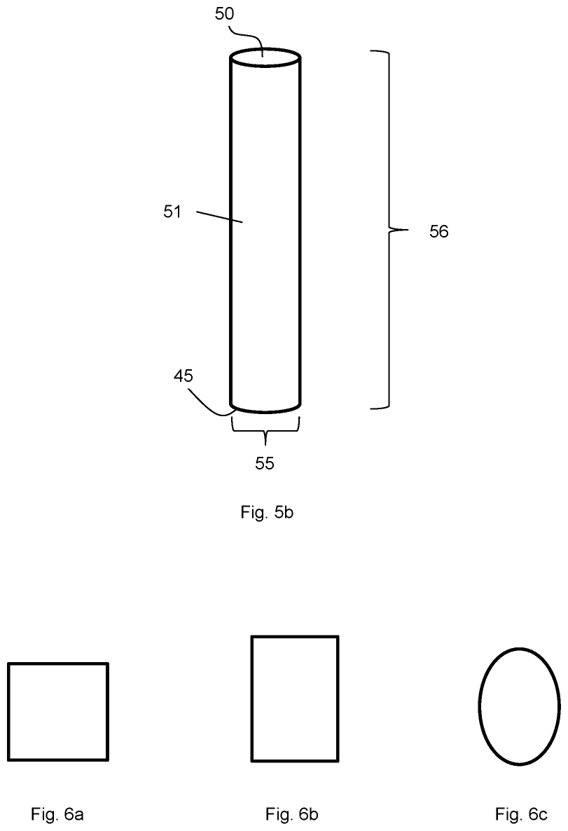

Top face 25 of the foundation further includes a plurality of bollards 15 that ensure that the centrally located kiosk is undamaged. The term “bollard” refers to any of a wide variety of structural posts. As shown in FIG. 5a, the bollards extend up from top face 25 of the foundation, surrounding kiosk 20. The bollards can be spaced from each other and aligned to form a barrier around the kiosk.

Each bollard 15 includes first end 45 and opposed second end 50 with body 51 therebetween, as shown in FIG. 5b. The first end of the bollard is attached to the top face of foundation 10 using any conventional mechanism, such as (but not limited to) welding, adhesive, cement, epoxy, mechanical elements (e.g., fasteners, clips, screws, bolts), magnets, and the like. In some embodiments, each bollard is permanently attached to top face 25 of the foundation. In other embodiments, the bollards are releasably attached to the foundation and can be added and removed on demand.

Bollard 15 includes length 55 (e.g., the longest horizontal distance of the bollard). The bollard can have any desired length, such as (but not limited to) about 3-15 inches (e.g., at least/no more than about 3, 4, 5, 6, 7, 8, 9, 10, 11, 12, 13, 14, or 15 inches). The bollard further includes height 56, which is the longest vertical distance of the element, from first end 45 to second end 50. Height 56 can range from about 20-60 inches (i.e., at least/no more than about 20, 25, 30, 35, 40, 45, 50, 55, or 60 inches). The bollard width is the longest straight line distance perpendicular to both the length and height and can be about 3-15 inches (e.g., at least/no more than about 3, 4, 5, 6, 7, 8, 9, 10, 11, 12, 13, 14, or 15 inches). It should be appreciated that the bollard length, width, and height can be configured outside the ranges given herein.

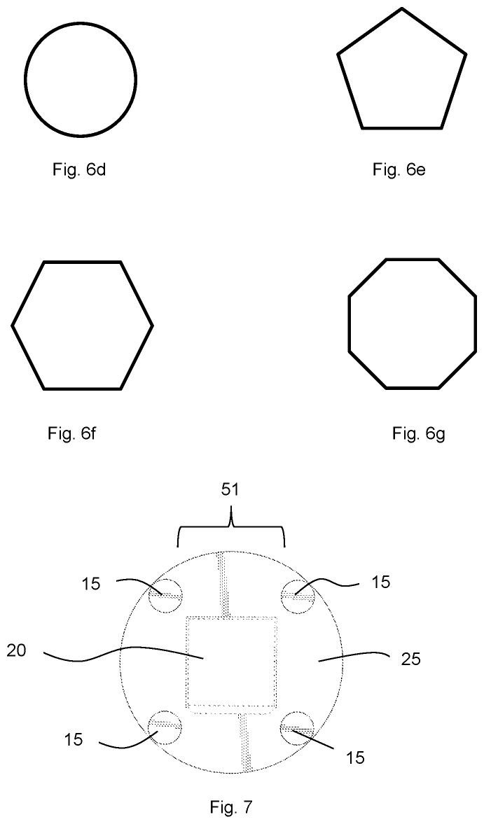

In some embodiments, bollards 15 can be cylindrically shaped. However, the bollard can have any desired cross-sectional shape, such as (but not limited to) square, rectangular, oval, circular, pentagonal, hexagon, octagonal, and the like, as illustrated in FIGS. 6a-6g.

Bollards 15 can be constructed from any desired material, such as (but not limited to) metal, cement, wood, plastic, or combinations thereof. For example, the bollards can be configured as a 10 inch×4 inch rectangular steel tube. The bollards can be structurally reinforced and adapted to resist impact (e.g., by a vehicle). Thus, the interior of bollards 15 can include reinforcement elements to strengthen the bollard. For example, a square tube with its corners coextensively engaged with and/or welded to the inner wall of the bollard greatly resists collapse. Further, the presence of disc-shaped transverse bulkheads at frequent intervals within the interior of the bollards resist collapse. Any structural elements can be used.

As set forth above, first end 45 of each bollard is attached to the top face of foundation 10. The bollards can be positioned about the perimeter of the foundation, as shown in FIG. 7. The space between each adjacent bollard creates opening 51 that is wide enough to allow a user's hands or arms to access the kiosk, but not so large that the kiosk can be accessed with a car or other vehicle. Thus, opening 51 can be about 3-15 inches (e.g., at least/no more than about 3, 4, 5, 6, 7, 8, 9, 10, 11, 12, 13, 14, or 15 inches). However, it should be appreciated that the opening can be configured outside the range given herein.

Foundation 10 and/or bollards 15 can optionally be painted or stained to achieve any aesthetic desired by the user. For example, the foundation can include dyed concrete. Alternatively or in addition, the foundation or bollards can be painted (e.g., powder coated steel paint). The base can further include any desired designs or words (e.g., branding, instructions for use, etc.).

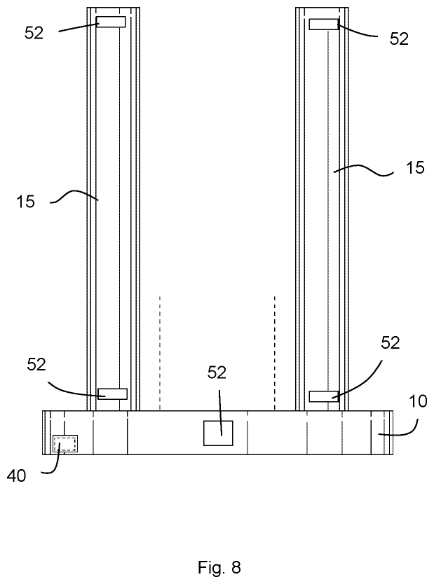

Base 5 can optionally include lighting to help users see the kiosk during low light conditions, such as evening or dark garages. For example, one or more bollards 15 and/or foundation 10 can include lighting 52, as shown in FIG. 8. The term “lighting” refers to any light source, such as (but not limited to) recessed or non-recessed bulbs, fluorescent lighting, and combinations thereof. The lighting can be positioned anywhere along bollard 15, such as facing the kiosk to improve user vision, towards the user, or anywhere in between. In some embodiments, the lighting is always illuminated. In other embodiments, the lighting is triggered by a timer or motion sensor.

Kiosk 20 can be permanently or releasably attached to the top face of the foundation using standard techniques. Specifically, the kiosk is positioned such that it is surrounded by bollards 15. In this way, the kiosk is shielded from damage, such as from accidental car bumps and the like. Any desired elements can be used to attach the kiosk to the top face of foundation 10. For example, the kiosk can be sized and shaped to fit into foundation recess 26. In some embodiments, bolts, fasteners, and other mechanical elements can be used.

Kiosk 20 is not limited and can be any device that interacts with a user. The kiosk can include a graphical user interface that allows the user to directly insert or remove one or more items (e.g., money, tickets, receipts) into or from the kiosk.

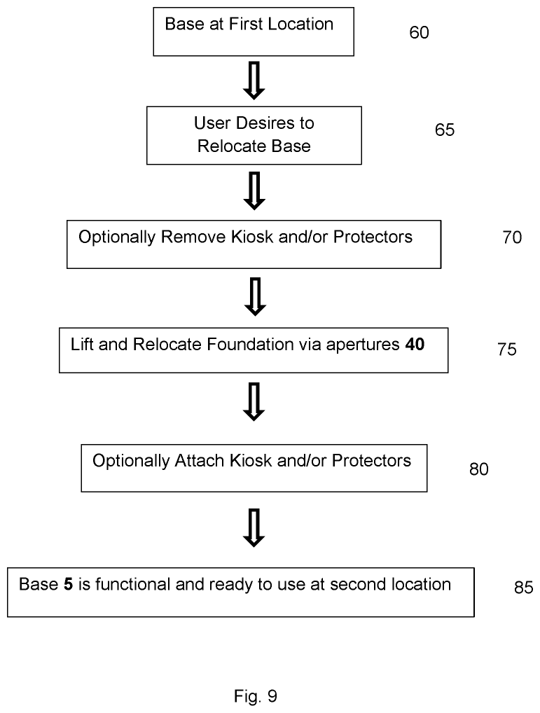

In use, base 5 is deposited at a desired location, such as at the entrance or exit of a parking garage or parking lot, as shown in step 60 in the flowchart of FIG. 9. When a user desires to relocate the base at steps 65 and 70, kiosk 20 and/or bollards 15 can be optionally removed from the top face of the foundation. The base can be moved using apertures 40, such as with a forklift or other heavy-lifting machinery at step 75. Particularly, the forks of a forklift can be inserted into apertures 40, thereby providing leverage to easily lift and move the base. The “fork” of a forklift refers to the tines that function to lift and carry heavy loads. In some embodiments, the foundation is first moved to a desired location, and the bollards and kiosk are later attached to the top face of the foundation at step 80. For example, snap-fit attachment, screw-fit attachments, the use of magnets, clips, fasteners, and the like can be used. In other embodiments, the kiosk and/or bollards are permanently attached to the foundation, such that the entire base can be moved as a single unit. The kiosk is then functional and can be used to distribute items (e.g., tickets, receipts), accept items (e.g., money, tickets), and the like, as indicated in step 85. The kiosk remains shielded and protected from vehicles and the like through bollards 15.

When an owner decides to relocate base 5, it can be easily repositioned from a first location to a second location. Specifically, apertures 40 enable the base to be easily and conveniently relocated. In some embodiments, the arms of a forklift can be inserted into the foundation apertures. The forklift arms can then be raised and lowered to reposition the base at a new location. Optionally, kiosk 20 and bollards 15 are permanently attached to the foundation such that the base can move as a single unit. However, the kiosk and/or bollards can be releasably attached to the foundation, allowing them to be added, removed, replaced, or switched out as desired by the user or by a particular application.

Base 5 offers many benefits over prior art kiosk cases. For example, the disclosed base is portable, allowing a user to change the location of the base as desired. In this way, the base can be easily moved depending on user preferences, a particular event, and the like.

The inclusion of apertures 40 ensures that the base can be safely and efficiently moved without damaging the foundation, kiosk, and/or bollards. Because the apertures extend into the interior of the foundation, the likelihood of damage to the base components are minimized.

Bollards 15 further reduce the likelihood of damage to the base or kiosk, acting as a protective shield. Thus, if a car intentionally or accidentally contacts the base, the bollards will protect the kiosk from damage.

Further, the weight of the base prevents theft or other illegal activity. Specifically, the weight of the base prohibits an unauthorized third party from attempting to remove the base from a first location.

These and other advantages would be apparent to those of ordinary skill in the art after a review of the present disclosure.

As described above, although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A kiosk base comprising:
a foundation defined by a top face with an outer edge, an opposed bottom face, and a sidewall that extends between the top face and bottom face;
one or more bollards positioned on the top face of the foundation, at or adjacent to the outer edge;
wherein the sidewall includes one or more apertures that extend into an interior of the sidewall.

2. The kiosk base of claim 1, wherein the foundation top face further includes a recess.

3. The kiosk base of claim 2, further comprising a kiosk positioned within the recess.

4. The kiosk base of claim 2, wherein the recess is positioned in an approximate center portion of the foundation top face.

5. The kiosk base of claim 1, wherein the apertures extend into the interior of the sidewall about 10-30 inches.

6. The kiosk base of claim 1, wherein a first aperture differs from a second aperture with regard to size, shape, or both.

7. The kiosk base of claim 1, comprising two apertures.

8. The kiosk base of claim 1, wherein a first aperture is spaced 6-24 inches from a second aperture on the sidewall.

9. The kiosk base of claim 1, wherein the foundation sidewall is rotatable relative to the top face, bottom face, or both.

10. The kiosk base of claim 1, comprising about 1-6 bollards.

11. The kiosk base of claim 1, wherein the bollards are releasably attached to the top face of the foundation.

12. The kiosk base of claim 1, comprising a distance between adjacent bollards that is about 3-15 inches.

13. The kiosk base of claim 1, wherein the foundation, at least one bollard, or both further includes at least one light source.

14. A method of moving a kiosk base from a first location to a second location, the method comprising:
positioning a kiosk base at a first location, wherein the kiosk base comprises:
a foundation defined by a top face with an outer edge, an opposed bottom face, and a sidewall that extends between the top face and bottom face;
one or more bollards positioned on the top face of the foundation, at or adjacent to the outer edge;
wherein the sidewall includes one or more apertures that extend into an interior of the sidewall;
relocating the kiosk base to a second location by inserting an object into each aperture to lift the kiosk base and transport it to the second location;
removing the objects from the apertures, whereby the kiosk base is moved from a first location to a second location.

15. The method of claim 14, wherein each object is a fork of a forklift.

16. The method of claim 14, wherein the bollards are removed prior to the relocating step.

17. The method of claim 14, further comprising releasably attaching a kiosk onto the top face of the kiosk base.

18. The method of claim 14, wherein the foundation sidewall rotates relative to the top face of the foundation to allow the apertures to be moved to a desired location prior to insertion of an object into each aperture.

19. The method of claim 14, wherein the apertures extend into the interior of the sidewall about 10-30 inches.

20. The method of claim 14, wherein the foundation, at least one bollard, or both further includes at least one light source.
